(19) United States
(12) Patent Application Publication
(10) Pub. No.: US 2022/0339815 A1
(43) Pub. Date: Oct. 27, 2022

(54) VIBRATION MOLDING DEVICE

(71) Applicant: TBM CO., LTD., Okayama-shi (JP)

(72) Inventor: Tetsugoro KITAHARA, Okayama-shi (JP)

(21) Appl. No.: 17/695,698

(22) Filed: Mar. 15, 2022

(30) Foreign Application Priority Data
Mar. 16, 2021 (JP) 2021-42732

(51) Int. Cl. B28B 1/087

(52) U.S. Cl. CPC B28B 1/0873; B28B 2001/0876

(57) ABSTRACT

A vibration molding device comprising a pedestal, a mold configured to contain molding material, a vibration stand on which the mold is placed, a vibration means to provide vibration to the mold, an elastic body that is placed between the vibration stand and the pedestal to support the vibration stand, wherein the vibration molding device is characterized in that a through hole is formed in the vibration stand, a descent restriction member which regulates the descending position of the vibration stand is erected on the top surface of the pedestal, the descent restriction member is disposed so that the descent restriction member penetrates the through hole.

### TECHNICAL FIELD

The present invention relates to a vibration molding device.

The method used to obtain a concrete molding body comprising soil, sand, gravel, or stiff-consistency concrete with low water content (hereinafter “molding material”) is to fill a mold with molding material and then apply vibration to the mold to tighten the molding material.

Patent Document PL1 discloses, for the purpose of providing a vibration compaction device capable of vibration compaction of concrete in a short time with low vibration and low noise, as shown in FIG. 14, discloses a vibration stand for concrete compaction 30 in which a pair of left and right single tables 21A and 21B supported and fixed on a foundation at both ends via anti-vibration rubbers 24 respectively are connected together at the center thereof by a connecting plate 22 to form a table 20, and a single vibrator 26 is installed at the center bottom surface of said connecting plate 22.

### PATENT LITERATURE

[PL1] JPH06-285871

### SUMMARY OF THE INVENTION

### Problems to be Solved by the Invention

When using conventional vibration molding equipment, it takes a long time to increase the filling rate of the material to be filled and it is not possible to obtain a high filling rate.

The objective of the present invention is to provide a vibration molding device with which a molding body with a high filling rate can be obtained in a short vibration time.

### Means for Solving the Problems

The invention that solves the above problem relates to the vibration molding device as described below.

A vibration molding device comprising: a pedestal, a mold configured to contain a molding material, a vibration stand on which the mold is placed, a vibration means to provide vibration to the mold, and an elastic body that is placed between the vibration stand and the pedestal to support the vibration stand, wherein the vibration molding device is characterized in that a through hole is formed in the vibration stand, a descent restriction member which regulates the descending position of the vibration stand is erected on the top surface of the pedestal, and the descent restriction member is disposed so that the descent restriction member penetrates the through hole.

### Effect of the Invention

By using the vibration molding device of present invention, a molding body having a high filling rate can be obtained in a short time.

### BRIEF DESCRIPTION OF THE DRAWINGS

FIG. 1A is a front view of an embodiment of the vibration molding device of the present invention.

FIG. 1B is a side view of the vibration molding device shown in FIG. 1A.

FIG. 2A shows a front view of an embodiment of the vibration molding device of the invention, and a schematic diagram showing the top surface of a descent restriction member and the bottom plate of the mold abutting together.

FIG. 2B is a side view of the vibration molding device shown in FIG. 2A.

FIG. 3 illustrates an example of the arrangement of various components of the vibration molding device in accordance with the present invention.

FIG. 4 schematically illustrates the vibration state of the vibration stand and the mold of the vibration molding device in an embodiment of the present invention.

FIG. 5 shows an example of the mounting structure of the descent restriction member in the vibration molding device in an embodiment of the present invention.

FIG. 6 shows an example of the mounting structure of the descent restriction member in the vibration molding device in an embodiment of the present invention.

FIG. 7 shows an example of the mounting structure of the descent restriction member in the vibration molding device in an embodiment of the present invention.

FIG. 8 shows an example of the mounting structure of the descent restriction member in the vibration molding device in an embodiment of the present invention.

FIG. 9A shows a front view of the vibration molding device, and an example of a vibrator attached to the mold.

FIG. 9B shows a side view of the vibration molding device shown in FIG. 9A.

FIG. 10 shows an example of the vibration molding device with a pressure device in an embodiment of the present invention.

FIG. 11 shows an example of the vibration molding device, where a mold without a bottom plate is used as the mold.

FIG. 12A shows the structure of a conventional vibration molding device in front view.

FIG. 12B is a side view of the vibration molding device shown in FIG. 12A.

FIG. 13 schematically shows the state of vibration of the vibration stand and the mold in the vibration molding device shown in FIG. 12A.

FIG. 14 shows a conventional vibration molding device.

### SOLUTIONS FOR THE PROBLEMS

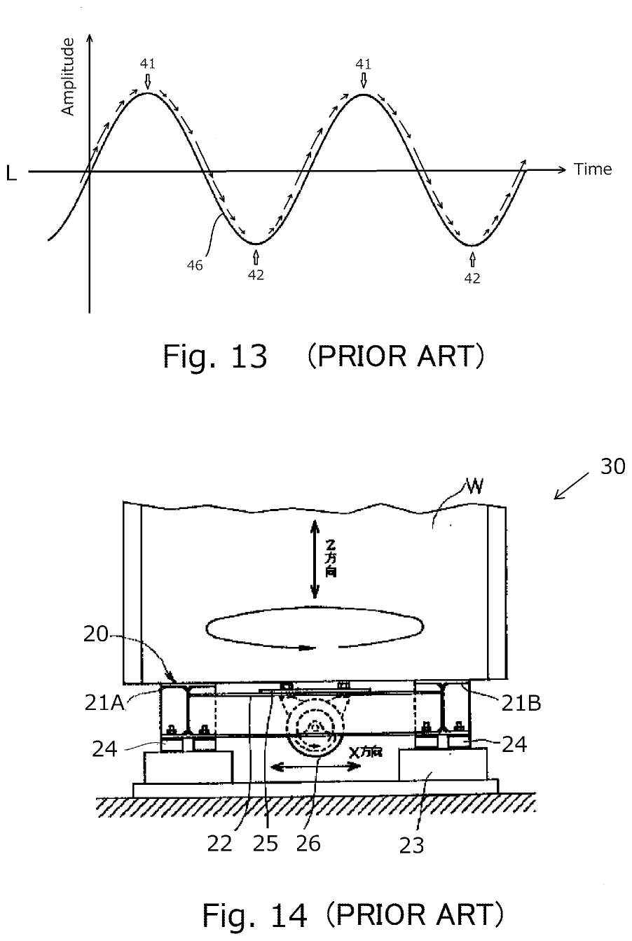

Prior to explaining the vibration molding device of the present invention, a conventional vibration molding device will be explained based on FIG. 12A, FIG. 12B and FIG. 13.

In explaining the effect of the descent restriction member in the present invention, a general vibration molding device without such a descent restriction member will be described.

FIG. 12A is a front view of a commonly used vibration molding device, and FIG. 12B is a side view of the vibration molding device shown in FIG. 12A. A pedestal 1 and a vibration stand 2 are connected by an elastic body 3, such as rubber vibration insulator or spring, and the vibration stand 2 is supported by this elastic body 3. The bottom surface of the vibration stand 2 has a vibrator 4 attached as a vibration means, and the operation of the vibrator 4 causes the vibration stand 2 to vibrate.

Also, the vibration of the vibration stand 2 is absorbed by the elastic body 3, preventing the vibration from being transmitted to the pedestal 1.

When a rigid body of the mold 6 containing a molding material 5 is placed on top of this vibration stand 2, and the vibrator 4 is operated, the vibration stand 2 vibrates mainly up and down, and the mold 6 vibrates in the same way. The state of vibration of the vibration stand 2 and the mold 6 at this time can be schematically represented as a sine curve in the graph shown in FIG. 13, where the vertical axis is the amplitude and the horizontal axis is the time.

Vibration causes the vibration stand 2 and the mold 6 to move up and down. The acceleration of the motion reaches its maximum when the sine curve crosses the center line L. The acceleration decreases as the sine curve approaches the ascent end 41 or the descent end 42, and becomes zero at the ascent end 41 or the descent end 42 of the sine curve, the acceleration becomes zero. During the vibration, the mold 6 and the molding material 5 inside the mold 6 move up and down, each having inertia proportional to the acceleration. For example, when the vibration stand 2 descends and starts to ascend at the descent end 42, the mold 6 follows the vibration stand 2 to reduce the acceleration until the acceleration of the mold 6 is reduced to zero at the descent end 42, after which it ascends while gradually increasing the acceleration.

Since the mold 6 and the molding material 5 inside the mold 6 are made of different materials in terms of specific gravity, etc., even if the mold 6 reaches the descent end 42 and the acceleration becomes zero, the molding material 5 still has inertia to descend. Due to the force of inertia, the molding material 5 is pressed against the bottom plate of the mold 6 at the descent end 42, and the filling rate increases. The mold 6 repeats the motion of ascent and descent due to vibration, wherein each time the mold 6 changes motion from ascent to descent at the ascent end 41 and the mold 6 changes motion from descent to ascent at the descent end 42, the filling rate of the molding material 5 gradually increases due to the inertia of the molding material 5.

In the general vibration described above, just before the mold 6 turns from descending to ascending or from ascending to descending, the acceleration of the mold 6 is already small, thus the inertia generated in the molding material 5 in proportion to acceleration is also small, thereby diminishing the force to increase the filling rate of the molding material 5 resulting in a small increase of the filling rate. As a result, the time to repeat the vibration becomes longer when trying to increase the filling rate, and even if the vibration is made for a long time, a high filling rate cannot be obtained due to the lack of inertia force, which are technical problems.

The present invention solves the above technical problems.

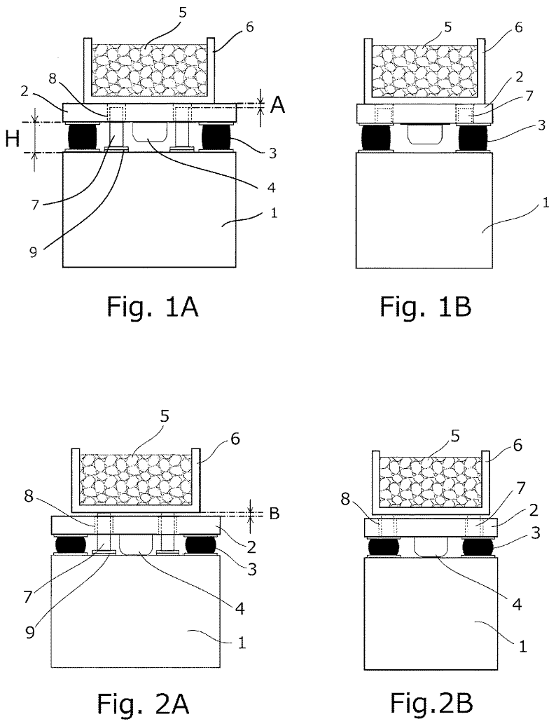

An example of an embodiment of the vibration molding device of the present invention is shown in FIG. 1A and FIG. 1B.
FIG. 1A is a front view of the vibration molding device, and FIG. 1B is a side view of the vibration molding device.

As shown in FIG. 1A, the descent restriction member 7 is fixed to the top surface of the pedestal 1 by bolts or other means.

In this embodiment, a spacer 9 made of a rigid body for height adjustment is inserted between the mounting part of the descent restriction member 7 and the pedestal 1 so that the height position of the top surface of the descent restriction member 7 can be adjusted. The mounting structure of the spacer 9 will be described later. On the other hand, a through hole 8 is formed at the position corresponding to the descent restriction member 7 in the vibration stand 2, so that the descent restriction member 7 can penetrate the through hole 8.

The descent restriction member 7 is installed in the through hole 8 opened in the vibration stand 2, so that when the vibrator 4 is stopped the length of the descent restriction member 7 is such that the top surface of the descent restriction member 7 is slightly lower than the top surface of the vibration stand 2.

Dimension A in FIG. 1A shows the difference in height between the top surface of the descent restriction member 7 and the top surface of the vibration stand 2.

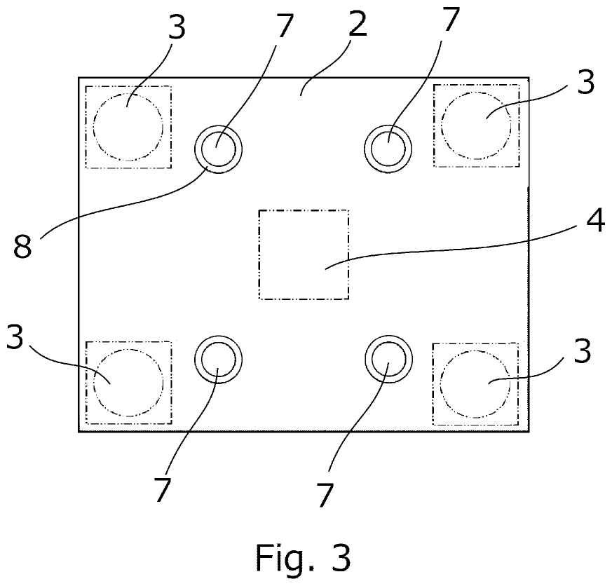

An example of the mounting position of the descent restriction member 7 in the vibration molding device is shown in FIG. 3.

FIG. 3 shows a view of the vibration stand 2 from the top. Four elastic bodies 3 are placed in the four corners of the vibration stand 2, and four through holes 8 are provided in the four outer corners of the vibrator 4, with the descent restriction member 7 penetrating into the through hole 8.

When a rigid mold 6 with molding material 5 is placed on top of the vibration stand 2, as shown in FIG. 1A, the elastic body 3 is slightly deformed by the weight of the vibration stand 6, and the distance (dimension H) between the top surface of the pedestal 1 and the bottom surface of the vibration stand 2 becomes shorter. The dimension H varies according to the weight of the vibration stand 6. Therefore, when the vibration stand 6 is filled with molding material 5, the height position of the top surface of the descent restriction member 7 is adjusted to keep the dimension A at 3-4 mm, which is a moderate dimension.

When the vibrator 4 is operated in this state, the vibration stand 2 and the mold 6 vibrate as schematically shown in the sine curve as described above. However, even if the vibration stand 2 is lowered by the vibration to a position below the top surface of the descent restriction member 7, the mold 6 collides with the top surface of the descent restriction member 7, and is blocked from descending.

When the mold 6 collides with the top surface of the descent restriction member 7, the descending acceleration of the mold 6 is still large, and the molding material 5 inside the mold 6 has a large inertia to descend. This causes a larger force of inertia to push the molding material 5 toward the bottom of the mold than when filling with a general vibration stand without the descent restriction member 7, which increases the filling rate of the molding material 5.

In this way, a larger force of inertia acts on molding material 5, which means that the same filling rate can be obtained in a shorter vibration time, or a higher filling rate can be obtained in the same vibration time.

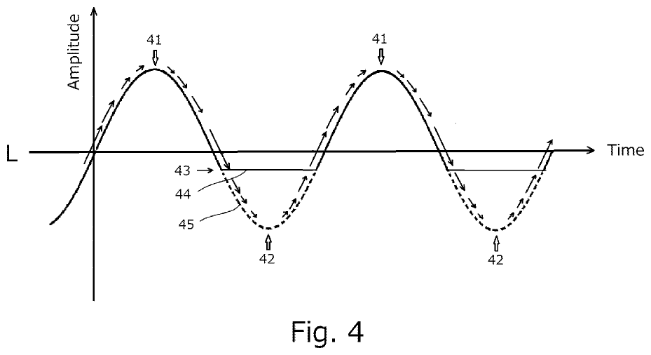

The function of the descent restriction member 7 is explained based on a sine curve shown in FIG. 4, which shows the vibration schematically.

As the vibration stand 2 and the mold 6 move downward from the ascent end 41 of the vibration, the acceleration of the vibration increases and reaches its maximum when they cross the center line L, and then they move toward the descent end 42 as the acceleration gradually decreases. Immediately after the mold 6 crosses the center line L, it collides with the top surface of the descent restriction member 7, and at this moment, the descent stops and the state is shown by the solid line. The vibration stand 2 continues to descend along the sine curve to the descent end as shown by the dashed line, then rises and collides with the mold 6, and rises together with the mold 6.

FIGS. 2A and 2B show schematically a state where the vibration stand 2 turns to ascend at the descending end of the vibration stand 2 after the vibration stand 2 continues to descend while the mold 6 has stopped descending after having collided with the top surface of the descent restriction member 7.

FIG. 2A shows the front view of the vibration molding device, and FIG. 2B shows the side view thereof.
Dimension B in FIG. 2A shows the difference in height between the top surface of the vibration stand 2 and the bottom surface of the mold 6.
The height position of the top surface of the descent restriction member 7 is adjusted so that dimension B is about 0.3 to 3 mm.

When the mold 6 collides with the descent restriction member 7, there is still a large downward acceleration of the mold 6, and the molding material 5 at that position has a larger inertia than when filling using the vibration stand 2 without the descent restriction member 7. At the moment the mold 6 collides with the descent restriction member 7, the molding material 5 has a large inertia toward the bottom of the mold 6, and the filling rate increases. In other words, the role of the descent restriction member 7 is to force the mold 6 to stop descending at the point where the molding material 5 has a large inertia.

Compared with a vibration molding device without the descent restriction member 7, the vibration molding device with the descent restriction member 7 installed can fill the molding material 5 in less vibration time to get the same filling rate of the molding material 5. This results in a saving of energy to run the vibrator 4. Also, it is possible to increase the filling rate of the molding material 5 without increasing the energy of the vibrator 4.

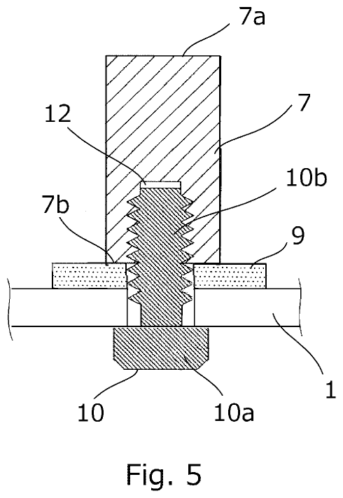

FIG. 5 shows the mounting structure of spacer 9 shown in FIG. 1A. A screw hole 12 is formed at the bottom of the descent restriction member 7. The descent restriction member 7 is erected on the top surface of the pedestal 1 by screwing screw threads 10b of a fixing bolt 10 into the screw hole 12 through the pedestal 1.

The height position of the top surface 7a of the descent restriction member 7 can be adjusted by placing a spacer 9 having appropriate dimensions (height) between the top surface of the pedestal 1 and the bottom surface 7b of the descent restriction member 7. A plurality of descent restriction members 7 with different heights may be prepared, but by preparing a plurality of spacers 9 with different dimensions (heights), only one type of descent restriction member needs to be prepared.

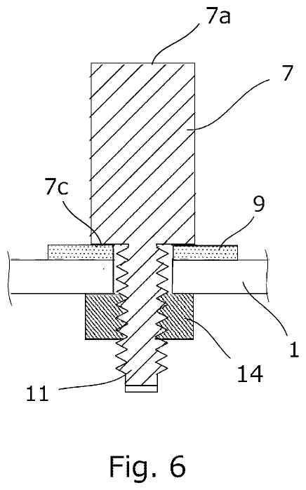

FIG. 6 shows another example of a mounting structure the spacer.

Screw threads 11 are formed at the bottom of the descent restriction member 7. The descent restriction member 7 is erected on the top surface of the pedestal 1 by screwing the screw threads 11 into a nut 14 through the pedestal 1.
The height position of the top surface 7a of the descent restriction member 7 can be adjusted by placing the spacer 9 with appropriate dimensions (height) between the top surface of the pedestal 1 and the seating surface of the head 7c of the descent restriction member 7.

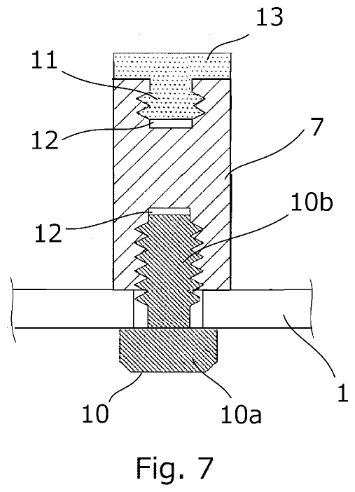

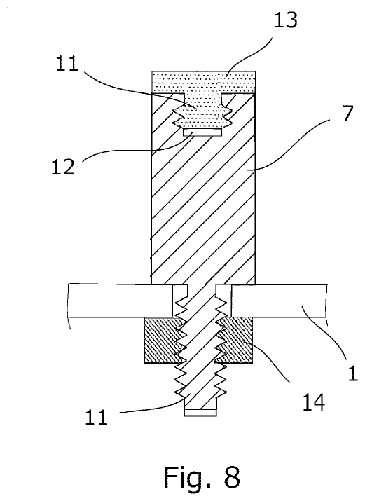

Other means of adjusting the height position of the top surface 7a of the descent restriction member 7 is shown in FIGS. 7 and 8.

FIGS. 7 and 8 show embodiments wherein the height of the descent restriction member 7 is adjusted by attaching a cap member 13, which consists of a rigid body with an appropriate height (thickness), to the top surface of the descent restriction member 7.

FIG. 7 shows that a screw hole 12 is formed at the bottom of the descent restriction member 7. The descent restriction member 7 is erected on the top surface of the pedestal 1 by screwing screw threads 10b of a fixing bolt 10 into the screw hole 12 through the pedestal 1.

The screw hole 12 is formed on the upper part of the descent restriction member 7, while the screw threads 11 are formed on the lower part of the cap member 13. The cap member 13 is attached by screwing the screw threads of the cap member 13 having an appropriate dimension (height) h to the screw hole 12 at the top of the descent restriction member 7. The cap member 13 constitutes the top part of the descent restriction member, and the top surface 13a of the cap member 13 is the top surface of the descent restriction member. By adjusting the dimension (height) h of the cap member 13, the height position of the top surface of the descent restriction member 7 can be adjusted.

FIG. 8 shows that screw threads 11 are formed at the bottom of the descent restriction member 7. The descent restriction member 7 is erected on the top surface of the pedestal 1 by screwing the screw threads 11 into a nut 14 through the pedestal 1.

The screw hole 12 is formed on the upper part of the descent restriction member 7, while the screw threads 11 are formed on the lower part of the cap member 13. The cap member 13 is attached by screwing the screw threads of the cap member 13 having an appropriate dimension (height) to the screw hole 12 at the top of the descent restriction member 7. The cap member 13 constitutes the top part of the descent restriction member, and the top surface 13a of the cap member 13 is the top surface of the descent restriction member. By adjusting the dimension (height) h of the cap member 13, the height of the descent restriction member 7 can be adjusted.

FIGS. 1 to 3 show the embodiment of a vibrator 4 attached to the vibration stand 2.

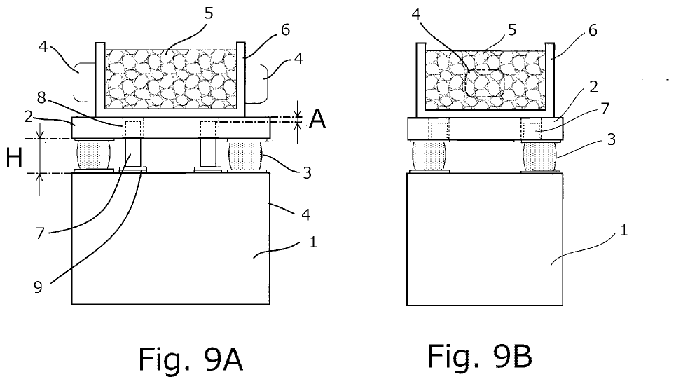

The vibrator 4 can also be attached to the mold 6, as shown in FIGS. 9A and 9B. FIG. 9a shows the front view of the vibration molding device with a vibrator attached to the left and right of the mold 6, and FIG. 9b shows its side view.
When the vibrator 4 is operated with the vibrator 4 being attached to the left and right of the mold 6, the vibration of the mold 6 is transmitted to the vibration stand 2, and the vibration stand 2 vibrates mainly up and down. In this case, the effect of installing the descent restriction member 7 can be obtained in the same way as when the vibrator 4 is installed on the vibration stand 2.

The vibration molding device of the present invention may be used the vibrator 4 as a filling means in combination with a pressurizing means to press the powder contained in the mold 6 from above with a pressure die.

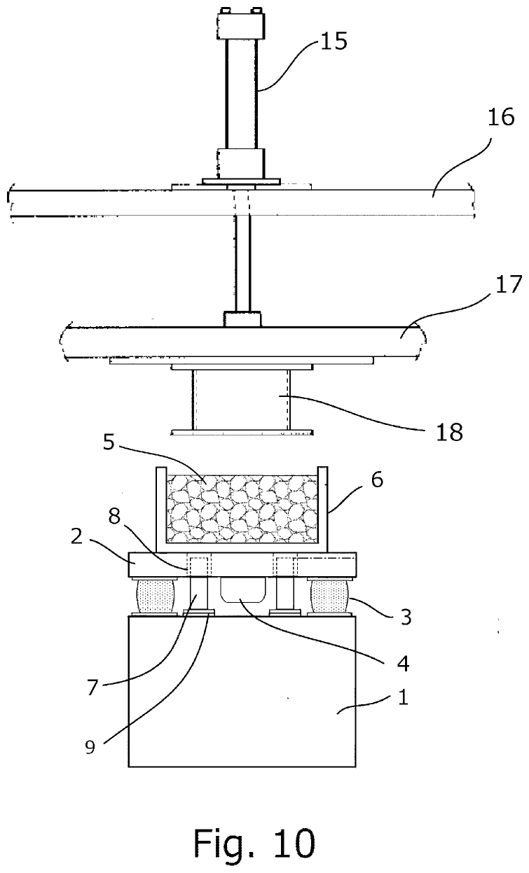

FIG. 10 shows an embodiment of using a vibrator 4 and a pressurizing means together.
In the example shown in FIG. 10, a press cylinder 15 is fixed by a support plate 16. The press cylinder 15 lowers a pressure plate 17 which is a pressure member and presses a pressure die 18 attached to the pressure plate 17 against the molding material in the vibrating mold 6. This pressurizes and forms molding material.

In the above embodiment, we have described an example of using a mold with a bottom plate as the mold.

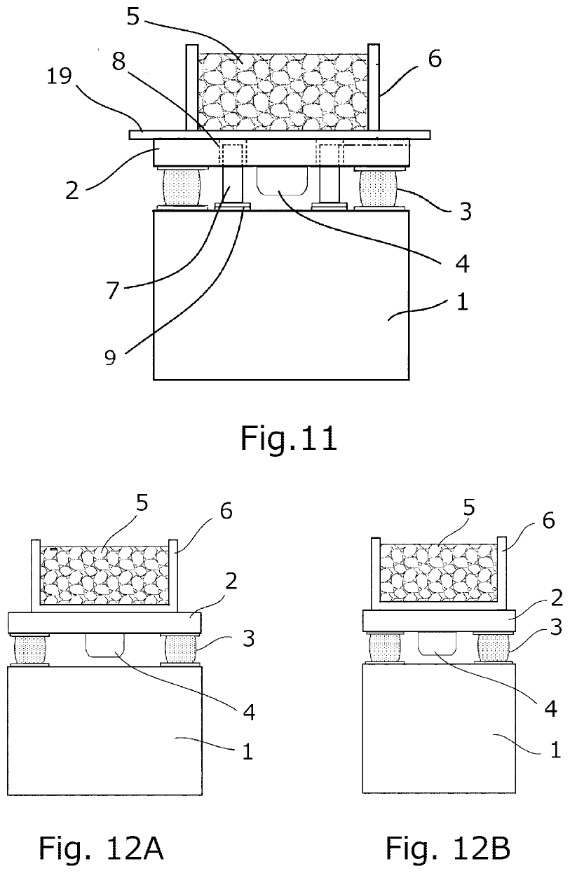

When using a mold without a bottom plate for the mold in the vibration molding device in accordance with the present invention, as shown in FIG. 11, a molding pallet 19 is placed on top of the vibration stand 2, and the mold 6 without a bottom plate is placed on top of the molding pallet 19. Then, the molding pallet 19 is used as the bottom plate of the mold 6 to feed powder into the mold 6 and the vibration stand 2 is vibrated, thereby powder is filled in the mold.

As described above, the action of the “descent restriction member” arranged to penetrate the through hole opened in the vibration stand can increase the filling rate of molding material in the mold in a shorter time or even obtain a higher filling rate. Thus, it is a great advantage that the energy required for vibration can be reduced by simply installing additional inexpensive components in the vibration stand.

The present invention, which is related to a vibration molding device in accordance with (1) below, includes the following (2) to (10) as embodiments.

(1) A vibration molding device comprising: a pedestal, a mold configured to contain a molding material, a vibration stand on which the mold is placed, a vibration means to provide vibration to the mold, and an elastic body that is placed between the vibration stand and the pedestal to support the vibration stand, wherein the vibration molding device is characterized in that a through hole is formed in the vibration stand, a descent restriction member which regulates the descending position of the vibration stand is erected on the top surface of the pedestal, and the descent restriction member is disposed so that the descent restriction member penetrates the through hole.
(2) The vibration molding device in accordance with (1) above, wherein the vibration means is attached to the vibration stand, and the vibration molding device is configured to provide vibration to the mold by vibrating the vibration stand with the vibration means.
(3) The vibration molding device in accordance with (1) above, wherein the vibration means is attached to the mold, and the mold is configured to be vibrated with the vibration means.
(4) The vibration molding device in accordance with any one of (1) to (3) above, wherein a pressing means to press the molding material contained in the mold from above is provided.
(5) The vibration molding device in accordance with any one of (1) to (4) above, wherein a mold without a bottom plate is used for the mold, a molding pallet is placed on top of the vibration stand, and the mold without a bottom plate is placed on top of the molding pallet.
(6) The vibration molding device in accordance with any one of (1) to (5) above, wherein the descent restriction member is erected on the top surface of the pedestal by a fixing bolt that is screwed, through the pedestal, into a screw hole formed at the bottom of the descent restriction member.
(7) The vibration molding device in accordance with any one of (1) to (5) above, wherein screw threads are formed at the bottom of the descent restriction member, and wherein the descent restriction member is erected on the top surface of the pedestal by screwing, through the pedestal, the screw threads formed at the bottom of the descent restriction member into a screw hole of a nut.
(8) The vibration molding device in accordance with any one of (1) to (5) above, further comprising a spacer for height adjustment between the top surface of the pedestal and the bottom surface of the descent restriction member.
(9) The vibration molding device in accordance with any one of (1) to (5) above, wherein the height of the descent restriction member is configured to be adjusted by attaching a cap member for height adjustment to the top part of the descent restriction member.
(10) The vibration molding device in accordance with any one of (1) to (9) above, wherein the descent restriction member comprises iron or resin.
(11) The vibration molding device in accordance with any one of (1) to (10) above, wherein the elastic body comprises at least one member selected from a rubber pillar, a metallic spring and an air spring.

### DESCRIPTION OF THE REFERENCE NUMERALS

1 pedestal
2 vibration stand
3 elastic body
4 vibration means(vibrator)
5 molding material
6 mold
7 descent restriction member
7a top surface of descent restriction member
7b bottom surface of descent restriction member
8 through hole
9 spacer
10 fixing bolt
10a screw head of fixing bolt
10b screw threads of fixing bolt
11 screw threads
12 screw hole
13 cap member
14 nut
15 press cylinder
16 support beam
17 pressure plate, pressure device
18 pressure die
19 molding pallet
20 table
21A, 21B single table
22 connecting plate
23 separation stand
24 anti-vibration rubber
25 mounting plate
26 vibrator
30 vibration stand for concrete compaction
41 ascent end
42 descent end
43 position of top surface of descent restriction member
44 movement of mold
45 movement of vibration stand
46 movement of mold and vibration stand

1. A vibration molding device comprising: a pedestal, a mold configured to contain a molding material, a vibration stand on which the mold is placed, a vibration means to provide vibration to the mold, and an elastic body that is placed between the vibration stand and the pedestal to support the vibration stand, wherein the vibration molding device is characterized in that a through hole is formed in the vibration stand, a descent restriction member which regulates the descending position of the vibration stand is erected on the top surface of the pedestal, and the descent restriction member is disposed so that the descent restriction member penetrates the through hole.

2. The vibration molding device according to claim 1, wherein the vibration means is attached to the vibration stand, and the vibration molding device is configured to provide vibration to the mold by vibrating the vibration stand with the vibration means.

3. The vibration molding device according to claim 1, wherein the vibration means is attached to the mold, and the mold is configured to be vibrated with the vibration means.

4. The vibration molding device according to claim 1, wherein a pressing means to press the molding material contained in the mold from above is provided.

5. The vibration molding device according to claim 1, wherein a mold without a bottom plate is used for the mold, a molding pallet is placed on top of the vibration stand, and the mold without a bottom plate is placed on top of the molding pallet.

6. The vibration molding device according to claim 1, wherein the descent restriction member is erected on the top surface of the pedestal by a fixing bolt that is screwed, through the pedestal, into a screw hole formed at the bottom of the descent restriction member.

7. The vibration molding device according to claim 1, wherein screw threads are formed at the bottom of the descent restriction member, and wherein the descent restriction member is erected on the top surface of the pedestal by screwing, through the pedestal, the screw threads formed at the bottom of the descent restriction member into a screw hole of a nut.

8. The vibration molding device according to claim 1, further comprising a spacer for height adjustment between the top surface of the pedestal and the bottom surface of the descent restriction member.

9. The vibration molding device according to claim 1, wherein the height of the descent restriction member is configured to be adjusted by attaching a cap member for height adjustment to the top part of the descent restriction member.

10. The vibration molding device according to claim 1, wherein the descent restriction member comprises iron or resin.

11. The vibration molding device according to claim 1, wherein the elastic body comprises at least one member selected from a rubber pillar, a metallic spring and an air spring.
